(19) United States
(12) Patent Application Publication
(10) Pub. No.: US 2022/0019223 A1
(43) Pub. Date: Jan. 20, 2022

(54) METHOD AND SYSTEM FOR DYNAMICALLY DETERMINING AND SEAMLESSLY SWITCHING TRAJECTORY PLANNER FOR AUTONOMOUS GROUND VEHICLES

(71) Applicant: Wipro Limited, Bangalore (IN)

(72) Inventors: R. Balaji Sunil KUMAR, Bengaluru (IN); Manas SARKAR, Kolkata (IN)

(21) Appl. No.: 17/034,377

(22) Filed: Sep. 28, 2020

(30) Foreign Application Priority Data
Jul. 15, 2020 (IN) 202041030052

(51) Int. Cl. G05D 1/02; G05D 1/00; G01C 21/34

(52) U.S. Cl. CPC G05D 1/0212; G05D 2201/0213; G01C 21/3492; G05D 1/0088

(57) ABSTRACT

This disclosure relates to method and system for dynamically determining and seamlessly switching trajectory planner (TP) for an Autonomous Ground Vehicle (AGV). The method includes determining a derived mission at a current position of the AGV along a global path based on static environment data from a navigation map and dynamic environment data acquired by the AGV. Further, the method includes identifying one or more potential TPs from a plurality of TPs based on the derived mission. Further, the method includes calculating a weighted suitability score for each of the one or more potential TPs based on a set of TP evaluation parameters. Further, the method includes determining a new TP from the one or more potential TPs to achieve the derived mission based on the weighted suitability score for each of the one or more potential TPs and a simulated evaluation of the new TP.

### TECHNICAL FIELD

This disclosure relates generally to Autonomous Ground Vehicles (AGVs), and more particularly to method and system for dynamically determining and seamlessly switching trajectory planner (TP) for an AGV.

### BACKGROUND

Autonomous Ground Vehicles (AGVs) are increasingly deployed in a variety of indoor and outdoor settings to facilitate efficient transportation. The AGVs are capable of sensing changing environment, and of accurately navigating with little or no human intervention. In order to enable autonomous navigation, an AGV is equipped with multiple sensors and control arrangements. The AGV determines velocity and trajectory based on input data received from various sensors (for example, position sensors, orientation sensors, visual sensors, etc.).

However, there may be situations when a change in environment may require a change in the velocity and the trajectory of the AGV. For example, when changing lanes from a speedy highway to a city road, the AGV may require a slower velocity and a greater number of stops when faced with obstacles (for example, another vehicle ahead of the AGV, another vehicle beside the AGV in a side lane, a passenger crossing the road, etc.). In particular, a trajectory planner (TP) applied to the AGV for a speedy highway may not be suitable on a city road.

In the present state of art, techniques for determining and switching to a new TP are limited in their scope and utility. For example, some conventional techniques provide for transitioning from one TP to another TP, based on situations. However, these techniques do not provide means for a dynamic and smooth transition between the two TPs that function in different velocity range. A sudden change from a current TP to a new TP may result in an uneven or an impractical behavior by the AGV (e.g., jerk, skid, temporarily stopping, etc.).

In short, existing techniques fall short in providing an effective mechanism for dynamically determining a new TP for the AGV. Further, the existing techniques fail to provide a mechanism for seamlessly transitioning from a current TP to the new TP of the AGV. Therefore, there is a need for techniques for dynamic determination and seamless transition of the TP in the AGV.

### SUMMARY

In one embodiment, a method of dynamically determining and seamlessly switching trajectory planner (TP) for an Autonomous Ground Vehicle (AGV) is disclosed. In one example, the method may include determining, by a navigation device, a derived mission at a current position of the AGV along a global path based on static environment data from a navigation map and dynamic environment data acquired by the AGV. The derived mission corresponds to a local objective of the AGV. Further, the method may include identifying, by the navigation device, one or more potential TPs from a plurality of TPs based on the derived mission. The plurality of TPs includes a current TP of the AGV. Further, the method may include calculating, by the navigation device, a weighted suitability score for each of the one or more potential TPs based on a set of TP evaluation parameters. The set of TP evaluation parameters includes at least one of an objective match score, a complexity score, and a data interpretation toughness score. Further, the method may include determining, by the navigation device, a new TP from the one or more potential TPs to achieve the derived mission based on the weighted suitability score for each of the one or more potential TPs and a simulated evaluation of the new TP. The simulated evaluation of the new TP includes determining a projected pose of the AGV by simulating a new trajectory plan by the new TP and evaluating the projected pose with respect to the local objective.

In one embodiment, a system for dynamically determining and seamlessly switching TP for an AGV is disclosed. In one example, the system may include a processor and a computer-readable medium communicatively coupled to the processor. The computer-readable medium may store processor-executable instructions, which, on execution, may cause the processor to determine a derived mission at a current position of the AGV along a global path based on static environment data from a navigation map and dynamic environment data acquired by the AGV. The derived mission corresponds to a local objective of the AGV. The processor-executable instructions, on execution, may further cause the processor to identify one or more potential TPs from a plurality of TPs based on the derived mission. The plurality of TPs includes a current TP of the AGV. The processor-executable instructions, on execution, may further cause the processor to calculate a weighted suitability score for each of the one or more potential TPs based on a set of TP evaluation parameters. The set of TP evaluation parameters includes at least one of an objective match score, a complexity score, and a data interpretation toughness score. The processor-executable instructions, on execution, may further cause the processor to determine a new TP from the one or more potential TPs to achieve the derived mission based on the weighted suitability score for each of the one or more potential TPs and a simulated evaluation of the new TP. The simulated evaluation of the new TP includes determining a projected pose of the AGV by simulating a new trajectory plan by the new TP and evaluating the projected pose with respect to the local objective.

In one embodiment, a non-transitory computer-readable medium storing computer-executable instructions for dynamically determining and seamlessly switching TP for an AGV is disclosed. In one example, the stored instructions, when executed by a processor, may cause the processor to perform operations including determining a derived mission at a current position of the AGV along a global path based on static environment data from a navigation map and dynamic environment data acquired by the AGV. The derived mission corresponds to a local objective of the AGV. The operations may further include identifying one or more potential TPs from a plurality of TPs based on the derived mission. The plurality of TPs includes a current TP of the AGV. The operations may further include calculating a weighted suitability score for each of the one or more potential TPs based on a set of TP evaluation parameters. The set of TP evaluation parameters includes at least one of an objective match score, a complexity score, and a data interpretation toughness score. The operations may further include determining a new TP from the one or more potential TPs to achieve the derived mission based on the weighted suitability score for each of the one or more potential TPs and a simulated evaluation of the new TP. The simulated evaluation of the new TP includes determining a projected pose of the AGV by simulating a new trajectory plan by the new TP and evaluating the projected pose with respect to the local objective.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for dynamically determining and seamlessly switching trajectory planner (TP) for an Autonomous Ground Vehicle (AGV), in accordance with some embodiments of the present disclosure.

FIG. 2 is a functional block diagram of a navigation device implemented by the exemplary system of FIG. 1, in accordance with some embodiments of the present disclosure.

FIGS. 3A and 3B illustrate a flow diagram of an exemplary process for dynamically determining and seamlessly switching TP for an AGV, in accordance with some embodiments of the present disclosure.

FIG. 4 is a flow diagram of a detailed exemplary process for dynamically determining and seamlessly switching TP for an AGV, in accordance with some embodiments of the present disclosure.

FIG. 5 illustrates determination of a derived mission, in accordance with some embodiments of the present disclosure.

FIG. 6 illustrates determination of one or more potential TPs, in accordance with some embodiments of the present disclosure.

FIG. 7 is an exemplary table of weighted suitability scores of a plurality of TPs for a plurality of derived missions, in accordance with some embodiments of the present disclosure.

FIGS. 8A and 8B illustrate exemplary simulated evaluation of a new TP with respect to that of a current TP, in accordance with some embodiments of the present disclosure.

FIG. 9 illustrates replacement of the current TP with the new TP to achieve the derived mission, in accordance with some embodiments of the present disclosure.

FIGS. 10A and 10B illustrate a comparison between a performance of the AGV as per the new TP and a simulated performance of the AGV as per the current TP, in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

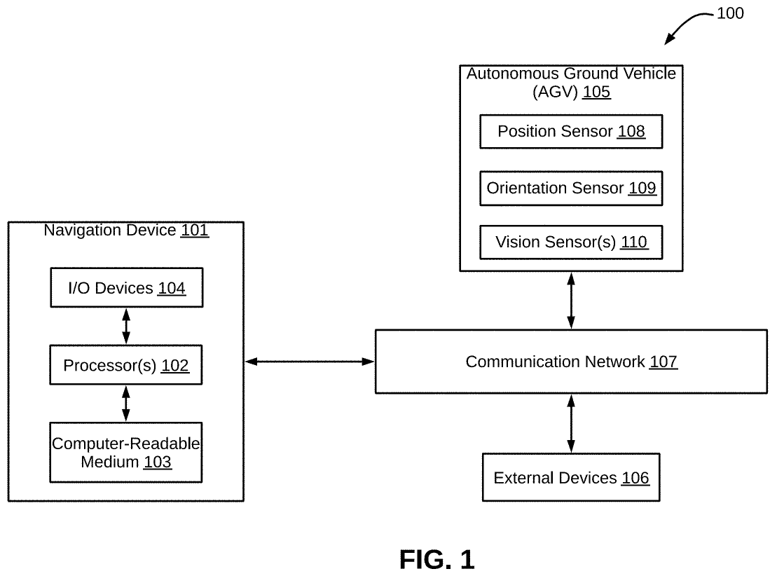

Referring now to FIG. 1, an exemplary system 100 for dynamically determining and seamlessly switching trajectory planner (TP) for an Autonomous Ground Vehicle (AGV) 105 is illustrated, in accordance with some embodiments of the present disclosure. In particular, the system 100 may include a navigation device 101 that may dynamically determine and seamlessly change the TP for the AGV 105, in accordance with some embodiments of the present disclosure. The navigation device 101 may dynamically determine the TP for the AGV 105 based on a weighted suitability score calculated for each of one or more potential TPs based on a set of TP evaluation parameters and a simulated evaluation of a new TP selected from the one or more potential TPs. It should be noted that, in some embodiments, the navigation device 101 may determine a derived mission at a current position of the AGV 105 along a global path based on static environment data from a navigation map and dynamic environment data acquired by the AGV 105. Further, the navigation device 101 may identify the one or more potential TPs from a plurality of TPs based on the derived mission. The navigation device 101 may take the form of any computing device including, but not limited to, a server, a desktop, a laptop, a notebook, a netbook, a tablet, a smartphone, and a mobile phone.

Further, as will be appreciated by those skilled in the art, the AGV 105 may be any vehicle capable of sensing the dynamic changing environment, and of navigating without any human intervention. Thus, the AGV 105 may include one or more sensors, a vehicle drivetrain, and a processor-based control system, among other components. The one or more sensors may sense dynamically changing environment by acquiring dynamic environment data. The sensors may include a position sensor 108, an orientation sensor 109, and one or more vision sensors 110. In some embodiments, the position sensor 108 may acquire an instant position (i.e., current location) of the AGV 105 with respect to a navigation map (i.e., within a global reference frame). The orientation sensor 109 may acquire an instant orientation (i.e., current orientation) of the AGV 105 with respect to the navigation map. The one or more vision sensors 110 may acquire an instant three-dimensional (3D) image of an environment around the AGV 105. In some embodiments, the 3D image may be a 360 degree field of view (FoV) of the environment (i.e. environmental FoV) that may provide information about presence of any objects in the vicinity of the AGV 105. Further, in some embodiments, the 3D image may be a frontal FoV of a navigation path (i.e., navigational FoV) of the AGV 105. By way of an example, the position sensor 108 may be a global positioning system (GPS) sensor, the orientation sensor 109 may be an inertial measurement unit (IMU) sensor, and the vision sensor 110 may be selected from a Light Detection And Ranging (LiDAR) scanner, a camera, a LASER scanner, a Radio Detection And Ranging (RADAR) scanner, a short-range RADAR scanner, a stereoscopic depth camera, or an ultrasonic scanner. Thus, the dynamic environment data may include, but may not be limited to, location data, orientation data, and vision data. The vision data may include, but may not be limited to, camera data, LiDAR data, and RADAR data.

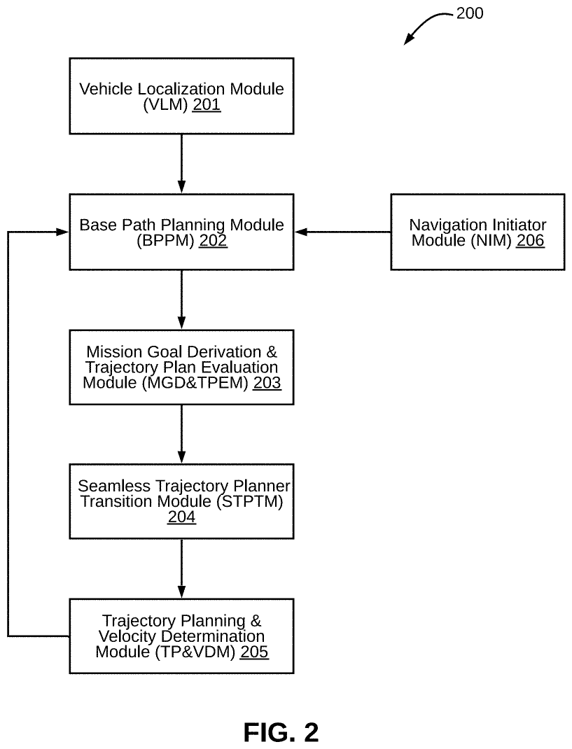

As will be described in greater detail in conjunction with FIGS. 2-10, the navigation device 101 may determine a derived mission at a current position of an AGV 105 along a global path based on static environment data from a navigation map and dynamic environment data acquired by the AGV 105. The derived mission may correspond to a local objective of the AGV 105. The navigation device 101 may further identify one or more potential TPs from a plurality of TPs based on the derived mission. The plurality of TPs may include a current TP of the AGV 105. The navigation device 101 may further calculate a weighted suitability score for each of the one or more potential TPs based on a set of TP evaluation parameters. The set of TP evaluation parameters may include at least one of an objective match score, a complexity score, and a data interpretation toughness score. The navigation device 101 may further determine a new TP from the one or more potential TPs to achieve the derived mission based on the weighted suitability score for each of the one or more potential TPs and a simulated evaluation of the new TP. The simulated evaluation of the new TP may include determining a projected pose of the AGV 105 by simulating a new trajectory plan by the new TP and evaluating the projected pose with respect to the local objective.

In some embodiments, the navigation device 101 may include one or more processors 102 and a computer-readable medium 103 (for example, a memory). The computer-readable storage medium 103 may store instructions that, when executed by the one or more processors 102, cause the one or more processors 102 to determine a new TP from the one or more potential TPs for the AGV 105 to achieve the derived mission based on the weighted suitability score for each of the one or more potential TPs and a simulated evaluation of the new TP, in accordance with aspects of the present disclosure. The computer-readable storage medium 103 may also store various data (for example, navigation map, static environment data from a navigation map, dynamic environment data acquired by the AGV 105, global path of the AGV 105, local path plan of the AGV 105, derived mission of the AGV 105, weighted suitability score for each of the one or more potential TPs, and the like) that may be captured, processed, and/or required by the system 100.

The system 100 may further include I/O devices 104. The I/O devices 104 may allow a user to exchange data with the navigation device 101 and the AGV 105. The system 100 may interact with the user via a user interface (UI) accessible via the I/O devices 104. The system 100 may also include one or more external devices 106. In some embodiments, the navigation device 101 may interact with the one or more external devices 106 over a communication network 107 for sending or receiving various data. The external devices 106 may include, but may not be limited to, a remote server, a plurality of sensors, a digital device, or another computing system. It may be noted that the external devices 106 may be fixed on the proximal vehicles and the proximal infrastructures and communicatively coupled with the AGV 105 via the communication network 107.

Referring now to FIG. 2, a functional block diagram of a navigation device 200 (analogous to the navigation device 101 implemented by the system 100 of FIG. 1) is illustrated, in accordance with some embodiments of the present disclosure. The navigation device 200 may include a vehicle localization module (VLM) 201, a base path planning module (BPPM) 202, a mission goal derivation & trajectory plan evaluation module (MGD&TPEM) 203, a seamless trajectory planner transition module (STPTM) 204, a Trajectory Planning and Velocity Determination Module (TP&VDM) 205, and a navigation initiator module (NIM) 206.

NIM 206 may be a UI. The NIM 206 may be configured to initiate navigation process from path planning to velocity generation to autonomously drive from a current location of the AGV 105 to a destination. It may be noted that the current location of the AGV 105 may be obtained through the VLM 201 and the destination may be provided by the user through the UI. The VLM 201 may determine the current location of the AGV 105 through a Global Positioning System (GPS). The UI may include a map displayed to the user. The user may observe the current location of the AGV 105 as a point on the map. In some embodiments, the UI may be touch-enabled. The user may provide the destination by touching on a map location on a drivable road area. Further, the NIM 206 may send the current location of the AGV 105 and the destination to the BPPM 202. The BPPM 202 may generate a global path for navigation of the AGV 105 from the current location of the AGV 105 to the destination using a shortest path algorithm, a Dijkstra algorithm, an A* algorithm, or any other path planning algorithm on a 2D occupancy grid map. It may be noted that the current location of the AGV 105 may be received by the BPPM 202 from the VLM 201. Further, the global path may be sent to the MGD&TPEM 203.

The MGD&TPEM 203 may determine the derived mission at the current position of the AGV 105 along the global path based on the static environment data received from the navigation map and/or the dynamic environment data acquired by the AGV 105. The derived mission may correspond to a local objective of the AGV 105. In an exemplary scenario, the derived mission for the AGV 105 may be to search for a parking space in a parking lot. In such a scenario, the current position of the AGV 105 is the parking lot, the static environment data received from the navigation map is a layout of the parking lot, and the dynamic environment data is parked vehicles in different parking slots as well as vehicles pulling-in and pulling-out of these parking slots. It may be noted that a current TP of the AGV 105 may not be suitable to achieve the derived mission. The MGD&TPEM 203 may determine one or more potential TPs from the plurality of TPs based on the derived mission. In some embodiments, the MGD&TPEM 203 may determine one or more potential TPs further based on the dynamic environment data. In some embodiments, the dynamic environment data may include at least one of camera data, Light Detection and Ranging (LIDAR) data, and short-range Radio Detection and Ranging (RADAR) data. It may be noted that the plurality of TPs may include the current TP of the AGV 105.

Further, for each of the one or more potential TPs, a weighted suitability score may be calculated by the MGD&TPEM 203 based on a set of TP evaluation parameters. By way of an example, the set of TP evaluation parameters may include at least one of an objective match score, a complexity score, and a data interpretation toughness score. Additionally, the MGD&TPEM 203 may determine a new TP from the one or more potential TPs to achieve the derived mission based on the weighted suitability score for each of the one or more potential TPs and a simulated evaluation of the new TP. It may be noted that the simulated evaluation of the new TP may include determining a projected pose of the AGV by simulating a new trajectory plan by the new TP and evaluating the projected pose with respect to the local objective.

The STPTM 204 may receive the new TP from the MGD&TPEM 203. Further, the STPTM 204 may replace the current TP of the AGV 105 with the new TP (determined by the MGD&TPEM 203) by determining a velocity range corresponding to the new TP for at least one navigation cycle. The STPTM 204 may send the velocity range of the new TP to the TP&VDM 205. The TP&VDM 205 may be configured to use a waypoint follower algorithm to move the AGV 105 towards a next waypoint. Further, a linear velocity and an angular velocity will be generated for the AGV 105 based on a mechanism of the waypoint follower algorithm from the current position of the AGV 105 to the next waypoint. The generated velocity will be within the velocity range of the new TP. Additionally, the STPTM 204 may evaluate an impact of replacing the current TP with the new TP to achieve the local objective. On determining an adverse impact, the STPTM 204 may switch back to the original TP. In other words, the STPTM 204 may switch back to the current TP (i.e., the TP that was replaced by the new TP) when the new TP is found to be not suitable for achieving the local objective. Thus, the STPTM 204 may send the velocity range of the current TP to the TP&VDM 205, which, in turn, will generate velocity within the velocity range of the current TP.

It should be noted that all such aforementioned modules 201-206 may be represented as a single module or a combination of different modules. Further, as will be appreciated by those skilled in the art, each of the modules 201-206 may reside, in whole or in parts, on one device or multiple devices in communication with each other. In some embodiments, each of the modules 201-206 may be implemented as dedicated hardware circuit comprising custom application-specific integrated circuit (ASIC) or gate arrays, off-the-shelf semiconductors such as logic chips, transistors, or other discrete components. Each of the modules 201-206 may also be implemented in a programmable hardware device such as a field programmable gate array (FPGA), programmable array logic, programmable logic device, and so forth. Alternatively, each of the modules 201-206 may be implemented in software for execution by various types of processors (e.g., processor 102). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for dynamically determining and seamlessly switching TP for the AGV 105. For example, the exemplary system 100 and the associated navigation device 101 may dynamically determine and seamlessly change TP for the AGV 105 by the processes discussed herein. In particular, as will be appreciated by those of ordinary skill in the art, control logic and/or automated routines for performing the techniques and steps described herein may be implemented by the system 100 and the associated navigation device 101 either by hardware, software, or combinations of hardware and software. For example, suitable code may be accessed and executed by the one or more processors on the system 100 and the associated navigation device 101 to perform some or all of the techniques described herein. Similarly, application specific integrated circuits (ASICs) configured to perform some or all of the processes described herein may be included in the one or more processors on the system 100 or the associated navigation device 101.

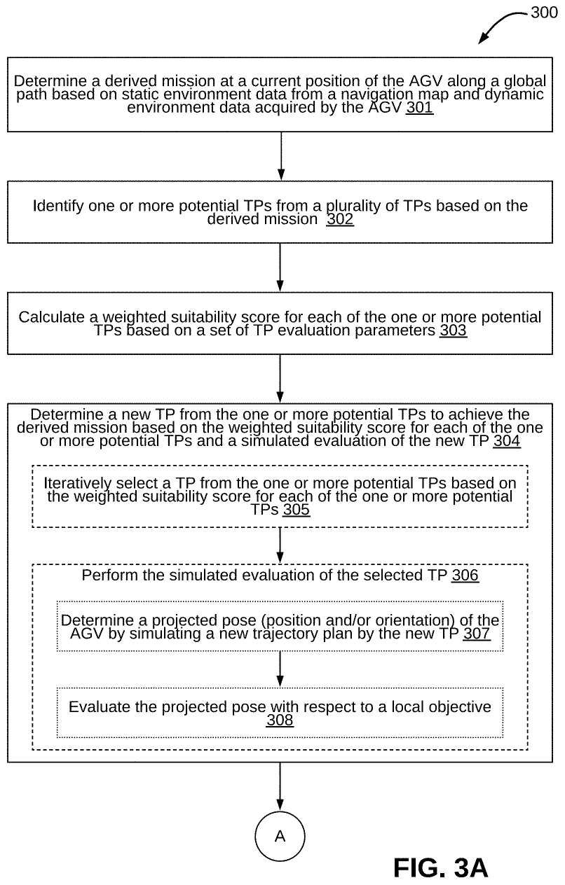

Referring now to FIGS. 3A and 3B, an exemplary method 300 for dynamically determining and seamlessly switching TP for the AGV 105 is illustrated via a flow chart, in accordance with some embodiments of the present disclosure. The method 300 may be implemented by the navigation device 100. The current position of the AGV 105 may be obtained through the GPS and the destination location may be provided by the user through the UI. In some embodiments, the VLM 201 may provide the current position of the AGV 105 and the NIM 206 may include the UI. The global path of the AGV 105 may be determined by the BPPM 202 based on the current position and the destination location.

The method 300 may include determining the derived mission at the current position of the AGV 105 along a global path based on the static environment data from the navigation map and dynamic environment data acquired by the AGV 105, at step 301. It may be noted that the derived mission corresponds to a local objective of the AGV 105. The navigation map may be displayed through the UI. At step 302, the method 300 may further include identifying one or more potential TPs from the plurality of TPs based on the derived mission. The plurality of TPs may include the current TP of the AGV 105. It may be noted that the plurality of TPs may be stored in a database. The database may be accessible by the navigation device 101. It may be noted that the dynamic environment data acquired by the AGV 105 may include at least one of camera data, Light Detection and Ranging (LIDAR) data, and short-range Radio Detection and Ranging (RADAR) data. In some embodiments, identifying the one or more potential TPs at step 302 is further based on the dynamic environment data.

Further, the method 300 may include calculating a weighted suitability score for each of the one or more potential TPs based on a set of TP evaluation parameters, at step 303. The set of TP evaluation parameters may include at least one of an objective match score, a complexity score, and a data interpretation toughness score. In some embodiments, the weighted suitability score may be directly proportional to the objective match score and inversely proportional to at least one of the complexity score and the data interpretation toughness score. The method 300 may further include, at step 304, determining a new TP from the one or more potential TPs to achieve the derived mission based on the weighted suitability score for each of the one or more potential TPs and a simulated evaluation of the new TP.

In some embodiments, the step 304 of the method 300 may include iteratively selecting a TP from the one or more potential TPs based on the weighted suitability score for each of the one or more potential TPs, at step 305, and performing the simulated evaluation of the selected TP, at step 306. In some embodiments, the simulated evaluation of the new TP may involve determining a projected pose (i.e., position and/or orientation) of the AGV 105 by simulating a new trajectory plan by the new TP, at step 30, and evaluating the projected pose with respect to the local objective, at step 308. It may be noted that the iteration may be performed until the projected pose for the selected TP is within a predefined threshold of a desired pose of the AGV as per the local objective. In other words, the iteration may be performed until a) a linear deviation of a projected position of the AGV with respect to a desired position as per the local objective is within a predefined linear threshold, and b) an angle of deviation of a projected orientation of the AGV with respect to a desired orientation as per the local objective is within a predefined angular threshold. The steps 301-308 may be performed by the MGD&TPEM 203 of the system 200.

Further, in some embodiments, the method 300 may include replacing the current TP with the new TP for at least one navigation cycle, at step 309. It may be noted that the step 309 may involve determining a velocity range corresponding to the new TP for at least one navigation cycle and sending the same to the TP&VDM 205 to generate velocity. In some embodiments, the method 300 may further include evaluating an impact of the replacement, at step 310. In some embodiments, the step 310 may involve evaluating a performance of the AGV 105 with respect to the derived mission based on navigation performed as per the new TP adapted by the AGV 105, at step 311. The step 310 may further involve evaluating a simulated performance of the AGV 105 with respect to the derived mission based on simulated navigation as per the current TP, at step 312. The step 310 may further involve comparing the performance of the AGV 105 with the simulated performance of the AGV 105 to decide between continuing with the new TP or switching back to the current TP, at step 313. In some embodiments, the method 300 may further include switching back to the current TP based on the evaluation of the impact, at step 314. It may be noted that the navigation device 101 may switch back to the current TP (i.e., the TP that was replaced by the new TP) when the simulated performance of the AGV 105 based on the current TP is better than the performance of the AGV 105 based on the new TP, with respect to the derived mission. It may be noted that the step 314 may involve determining the velocity range corresponding to the current TP and sending the same to the TP&VDM 205 to generate velocity. The steps 309-315 may be performed by the STPTM 204 of the system 200.

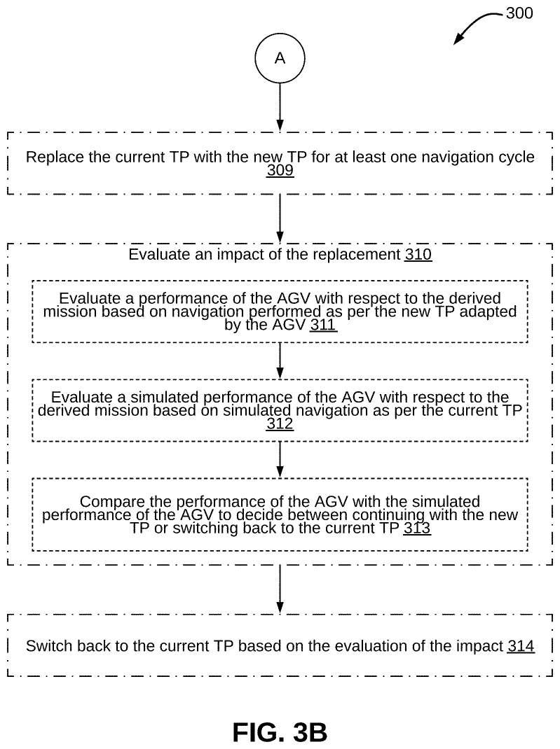

Referring now to FIG. 4, a detailed exemplary method 400 for dynamically determining and seamlessly switching TP for the AGV 105 is illustrated via a flow chart, in accordance with some embodiments of the present disclosure. It may be noted that the method 400 may be implemented by the navigation device 101 of the system 100. The method 400 may include initiating navigation and producing a global path, at step 401. The NIM 206 may initiate the navigation of the AGV 105 from path planning to velocity generation to autonomously drive from a source location (for example, the current position of the AGV 105) to the destination. Further, the BPPM 202 may determine the global path for the AGV 105 from the current position to the destination based on the source location and the destination. A part of global path, (for example, 10-20 meters from global path point) is required by the AGV 105 for motion. In some embodiments, the VLM 201 may use a camera-based location identification by observing unique landmarks and collecting previous observation data records from a known position.

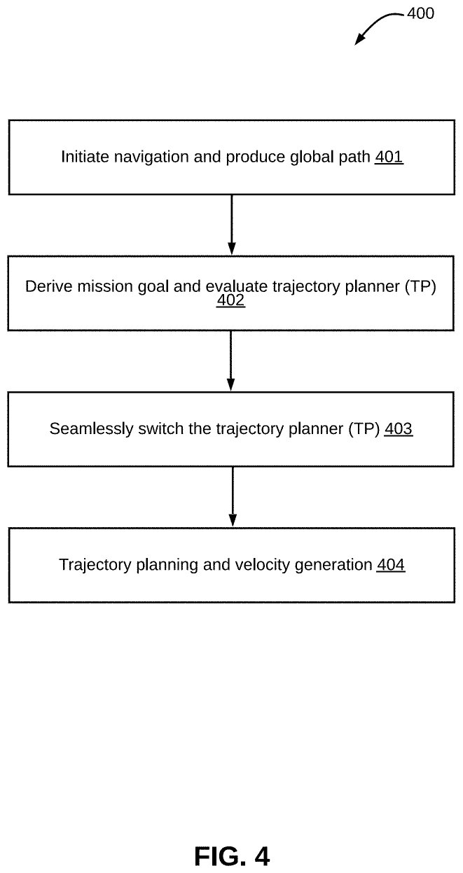

Further, the method 400 may include deriving the mission goal and evaluating TP, at step 402. In some embodiments, the derived mission at the current position of the AGV 105 along the global path may be determined by the MGD&TPEM 203. This is further explained in conjunction with FIG. 5. Referring now to FIG. 5, determination of the derived mission 501 is illustrated, in accordance with some embodiments of the present disclosure. It may be noted that the derived mission 501 at the current position of the AGV 105 along the global path may be determined by the MGD&TPEM 203 based on a mission goal and global plan 502, a local HD map 503, and sensor perception information 504. The mission goal and global plan 502 correspond to a current position of the AGV 105 along the global path, and the local HD map 503 corresponds to static environment data at the current position from the navigation map. It may be noted that the mission goal and global plan 502 and the local HD map 503 of the AGV 105 may provide a first level hint for the derived mission. It may be noted that the derived mission 501 may be an adjustment of the mission goal and global plan 502 of the AGV 105 based on the static environment data from the local HD map 503. The derived mission 501 may be further adjusted based on the sensor perception information 504. The sensor perception information 504 corresponds to dynamic environment data acquired by the sensors mounted on the AGV 105. Thus, the sensor perception information 504 may provide a second level hint for the derived mission. For example, the derived mission 501 may be to move the AGV 105 from a service lane to a speedy highway. By way of another example, the derived mission 501 may be to look for a temporary parking for the AGV 105 on a roadside. By way of yet another example, the derived mission 501 may be to search for a parking space in a parking lot for parking the AGV 105.

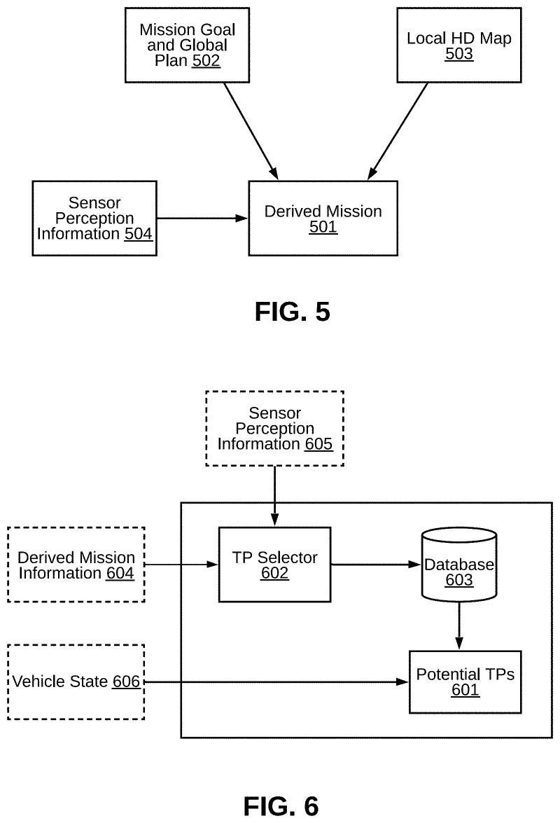

Further, one or more potential TPs may be determined by the MGD&TPEM 203 for the AGV 105 based on the derived mission 501 and the dynamic environment data acquired by the AGV 105. Referring back to FIG. 4, the step 402 may further involve identifying the one or more potential TPs based on the derived mission 501. The one or more identified TPs may be further narrowed down based on the dynamic environment data acquired by the AGV 105. This is further explained in conjunction with FIG. 6. Referring now to FIG. 6, determination of the one or more potential TPs 601 is illustrated, in accordance with some embodiments of the present disclosure. The one or more potential TPs 601 may be determined by a TP selector 602 from the plurality of TPs stored in a database 603. The TP selector 602 may determine the one or more potential TPs 601 based on the derived mission information 604 (analogous to the derived mission 501) and sensor perception information 605 of the AGV 105. As stated above, the sensor perception information 605 of the AGV 105 may be analogous to the dynamic environment data acquired by the AGV 105. By way of an example, the sensor perception information 605 acquired by the AGV 105 may include a sudden roadblock ahead, a busy traffic junction, and the like.

It should be noted that for each of the sensor perception information 605, a suitable TP may be available from among the plurality of TPs stored in the database 603. By way of an example, when the AGV 105 may face a roadblock, a suitable TP may be a free space planner for turning reverse, even when the AGV 105 is on a highway. The free space planner may further depend on level of forward backward maneuvering required by the AGV 105. In an exemplary scenario, the derived mission information 604 for the AGV 105 may include a transition from a high-speed highway lane to a city road and the sensor perception information 605 may include one of a vehicle break-down at a merging path, or a very heavy traffic. In such a scenario, the TP selector 602 may identify a free space planner with obstacle avoidance as a potential TP.

A new TP may be selected from the one or more potential TPs 601 based on the weighted suitability score for each of the one or more potential TPs 601 and a simulated evaluation of the new TP. It may be noted that a vehicle state 606 of the AGV 105 may be determined by simulating the new TP and comparing the vehicle state 606 with the derived mission information 604. Referring back to FIG. 4, the step 402 may further involve calculating a weighted suitability score for each of the one or more potential TPs based on the set of TP evaluation parameters. The set of TP evaluation parameters may include an objective match score Oₘ (about 0.1 to about 0.9), a complexity score Cₐ (about 1 to about 10), and a data interpretation toughness score Cₚ (about 1 to about 10). It should be noted that, in some embodiments, the data interpretation toughness score Cₚ may be with respect to the dynamic environment data acquired by the sensors. For example, a camera data interpretation may be more complex than LIDAR data interpretation and RADAR data interpretation may be more complex than camera data interpretation. It may be noted that, in some embodiments, the weighted suitability score is directly proportional to the objective match score and is inversely proportional to at least one of the complexity score and the data interpretation toughness score. By way of an example, in some embodiments, the weighted suitability score may be determined as per equation (1) below:

Wt=Oₘ*[2*(1/Cₐ+1/Cₚ)] Equation (1)

In some exemplary scenarios, for a particular environment, TPs from different vendors may be present in the database. In such scenarios, the weighted suitability score of the TPs may be calculated based on the complexity score Cₐ and the data interpretation toughness score Cₚ. Further, the one or more potential TPs may be sent for evaluation in the order of the weighted suitability score.

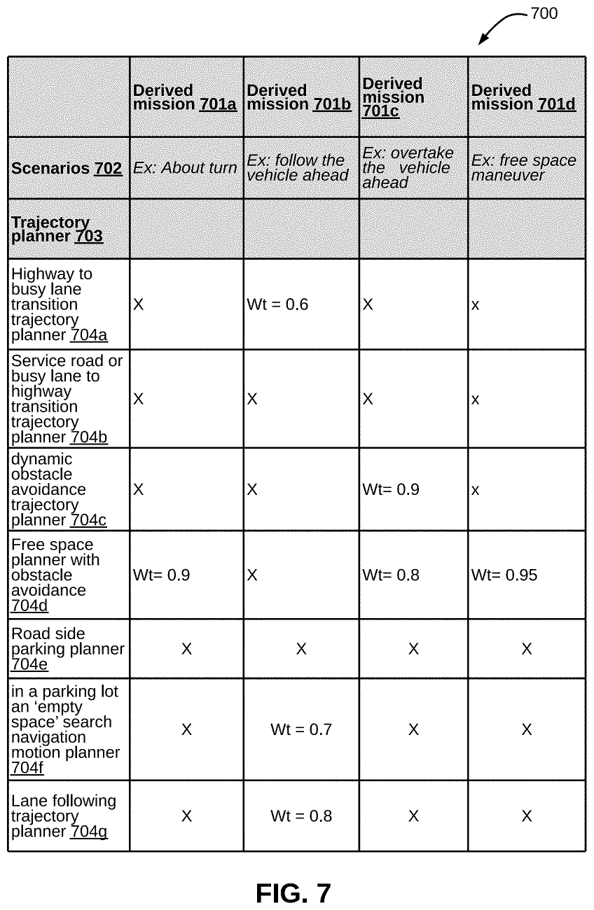

Referring now to FIG. 7, an exemplary table 700 of weighted suitability scores of a plurality of TPs 703 for a plurality of derived missions is illustrated, in accordance with some embodiments of the present disclosure. The table 700 includes the plurality of derived missions corresponding to a plurality of scenarios 702 for the AGV 105. By way of an example, the plurality of derived missions may include a derived mission 701a, a derived mission 701b, a derived mission 701c, and a derived mission 701d. Further, the derived mission 701a may correspond to an exemplary scenario of taking an about turn, the derived mission 701b may correspond to an exemplary scenario of following a vehicle ahead, the derived mission 701c may correspond to an exemplary scenario of overtaking a vehicle ahead, and the derived mission 701d may correspond to an exemplary scenario of a free space maneuver. The plurality of TPs 703 may include a highway to busy lane transition trajectory planner 704a, a service road or busy lane to highway transition trajectory planner 704b, a dynamic obstacle avoidance trajectory planner 704c, a free space planner with obstacle avoidance 704d, a road side parking planner 704e, a parking lot ‘empty space’ search navigation motion planner 704f, and a lane following trajectory planner 704g. For each of the plurality of TPs, the weighted suitability score is calculated based on each of the plurality of derived missions. For example, the weighted suitability score of highway to busy lane transition trajectory planner 704a for the derived mission 701b is 0.6. The weighted suitability score is represented as “x” when a TP is not identified as suitable for the derived mission.

Referring back to FIG. 4, the step 402 may further involve a simulated evaluation of the new TP to check the projected pose (i.e., position and/or orientation) of the AGV 105 with respect to the local objective (i.e., the derived mission). The navigation device 101 may switch from the current TP to the new TP when results (i.e., the projected pose) of the simulated evaluation may be within a predefined threshold of a desired pose of the AGV as per the derived mission. Further, when results of the simulated evaluation may not be within the predefined threshold, the AGV 105 may evaluate the trajectory planner with the next best weighted suitability score. It may be noted that the navigation device 101 may switch from the current TP to the new TP after evaluating the projected pose of the AGV 105 with respect to the derived mission for at least one of the one or more potential TPs from the database 603.

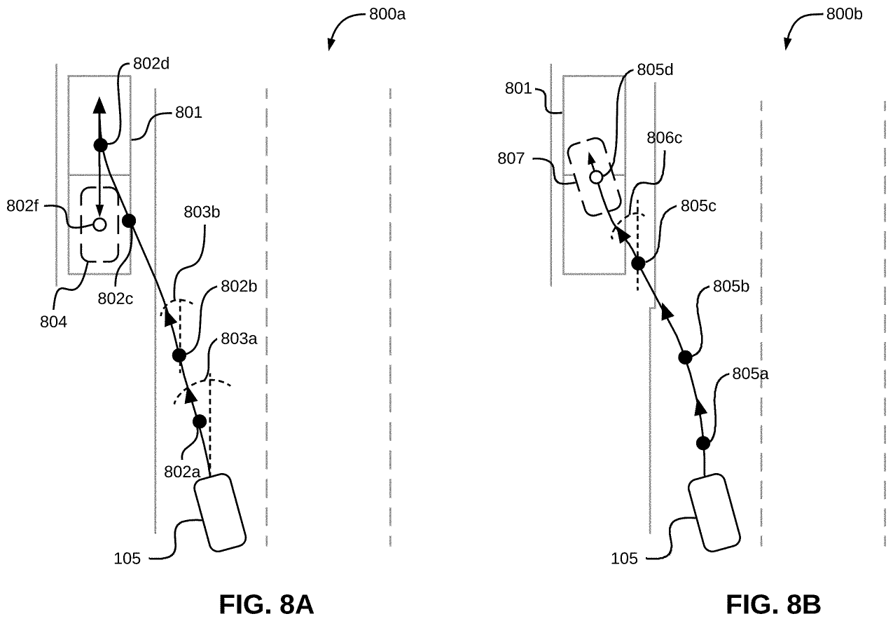

Referring now to FIGS. 8A and 8B, exemplary simulated evaluation of a new TP with respect to that of the current TP is illustrated, in accordance with some embodiments of the present disclosure. By way of an example, the new TP may be suitable for a roadside parking scenario. In FIG. 8A, a simulated evaluation 800a for the new TP of the AGV 105 in a parking lot 801 is illustrated. The simulated evaluation 800a includes a set of trajectory plan points and a set of angles of deviation with respect to a roadside parking. The set of trajectory plan points may include a trajectory plan point (Wp1) 802a, a trajectory plan point (Wp2) 802b, a trajectory plan point (Wp3) 802c, a trajectory plan point (Wp4) 802d, a trajectory plan point (Wp5) (between Wp4 and Wp6, not shown in figure), and a trajectory plan point (Wp6) 802f. It may be noted that an angle of deviation may be determined for each of the set of trajectory plan points in the simulated evaluation 800a. The set of angles of deviation may include an angle of deviation (α₁) 803a, an angle of deviation (α₂) 803b, an angle of deviation (α₃) (not shown in figure), an angle of deviation (α₄) (not shown in figure), an angle of deviation (α₆) (not shown in figure), and an angle of deviation (α₆) (not shown in figure).

Further, the simulated evaluation 800a may include a projected pose 804 of the AGV 105. It may be noted that the projected pose 804 corresponds with the Wp6. Thus, the new trajectory plan may be generated with Wp1, Wp2, Wp3, Wp4, Wp5, Wp6. Total alignment deviation (Tad) with respect to road or roadside parking may be determined as per equation (2) below:

Tad=α₁+(α₂−α₁)+(α₃−α₂)+(α₄−α₃)+(α₆−α₄)+(α₆−α₆) Equation (2)

In FIG. 8B, an evaluation 800b for the current TP of the AGV 105 in the parking lot 801 is illustrated. The evaluation 800b includes a set of trajectory plan points and a set of angles of deviation with respect to a roadside parking. The set of trajectory plan points may include a trajectory plan point (Wp′1) 805a, a trajectory plan point (Wp′2) 805b, a trajectory plan point (Wp′3) 805c, and a trajectory plan point (Wp′4) 805d. It may be noted that an angle of deviation may be determined for each of the set of trajectory plan points in the simulated evaluation 800b. The set of angles of deviation may include an angle of deviation (α′₁) (not shown in figure), an angle of deviation (α′₂) (not shown in figure), an angle of deviation (α′₃) 806c, and an angle of deviation (α′₄) (not shown in figure).

Further, the evaluation 800b may include a projected pose 807 of the AGV 105. It may be noted that the projected pose 807 corresponds with the Wp′4. The trajectory plan may include Wp′1, Wp′2, Wp′3, Wp′4. Total alignment deviation (Tad′) with respect to road or roadside parking may be determined as per equation (3) below:

Tad′=α′₁+(α′₂−α′₁)+(α′₃−α′₂)+(α′₄−α′₃) Equation (3)

It may be noted that Tad is more aligned with respect to the roadside than Tad′. In other words, Tad is less deviated with respect to the roadside than Tad′. Thus, the new TP may be more suitable to achieve the derived mission than the current TP. Further, each of the one or more potential TPs may be iteratively evaluated until a suitable TP is obtained for achieving the derived mission.

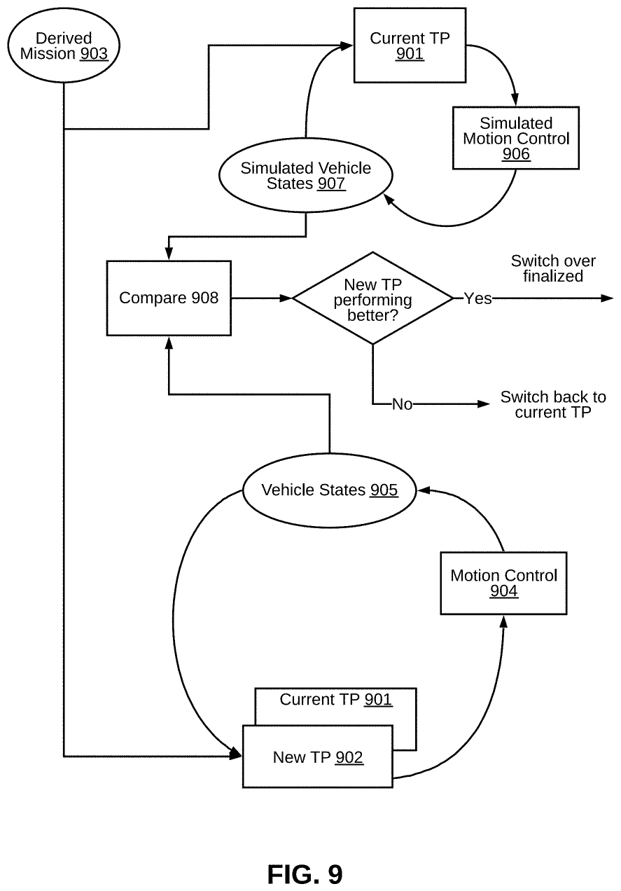

Referring back to FIG. 4, the method 400 may further include seamless switching of TP, at step 403. The new TP may be selected based on the simulated evaluation and applied to the AGV 105 for achieving the derived mission. However, to achieve a smooth transition from the current TP to the new TP, the current TP may not be directly replaced with the new TP. Referring now to FIG. 9, replacement of the current TP 901 with the new TP 902 to achieve the derived mission 903 is illustrated, in accordance with some embodiments of the present disclosure. It may be noted that when the derived mission 903 is determined by the MGD&TPEM 203, the new TP 902 may be determined from the one or more potential TPs. By way of an example, the derived mission 903 may be determined to be occurring in about 700 millisecond (ms).

Further, a motion control 904 may be performed to replace the current TP 901 with the new TP 902. The motion control 904 may include generating the velocity range corresponding to the new TP 902 in the current TP 901 for at least one navigation cycle. It may be noted that for motion control 904, the velocity range corresponding to the new TP 902 may act as a bounding range on the current TP 901 to change a current velocity of the AGV 105 to a controlling range of the new TP 902. A vehicle state 905 may be evaluated upon applying the motion control 904. By way of an example, the vehicle state 905 may include a pose and a velocity twist of the AGV 105. In some embodiments, a loop of performing the motion control 904 using the new TP 902 and evaluating the vehicle state 905 (i.e., the at least one navigation cycle) may be of about 200 ms.

Further, a simulated evaluation may be performed, simultaneously, of the current TP 901. The simulated evaluation of the current TP 901 may include a simulated motion control 906 and a simulated vehicle state 907 of the AGV 105 for the at least one navigation cycle (e.g., 200 ms loop). Further, each of the vehicle state 905 corresponding to the new TP 902 and the simulated vehicle state 907 corresponding to the current TP 901 may be compared 908 to evaluate an adherence of each of the vehicle state 905 and the simulated vehicle state 907 with the derived mission 903. The current TP 901 may be replaced with the new TP 902 when the vehicle state 905 as per the new TP may be more suitable for achieving the derived mission 903 than the simulated vehicle state 907 as per the current TP 901 based on the comparison 908. It may be noted that the navigation device 101 may switch back to the current TP 901 when the vehicle state 905 as per the new TP may be less suitable for achieving the derived mission 903 than the simulated vehicle state 907 as per the current TP 901 based on the comparison 908.

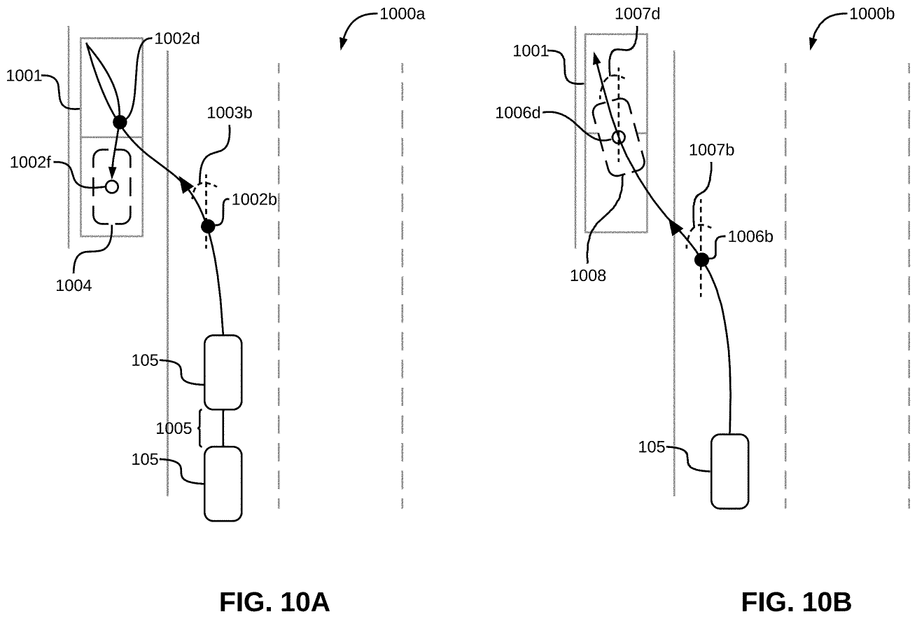

Referring now to FIGS. 10A and 10B, a comparison between a performance 1000a of the AGV 105 as per the new TP and a simulated performance 1000b of the AGV 105 as per the current TP is illustrated, in accordance with some embodiments of the present disclosure. By way of an example, the new TP may be suitable for a roadside parking scenario. In FIG. 10A, the performance 1000a as per the new TP of the AGV 105 in a parking lot 1001 is illustrated. The performance 1000a includes a set of trajectory points and a set of angles of deviation with respect to a roadside parking. The set of trajectory points may include a trajectory plan point (Wp1) (not shown in figure), a trajectory plan point (Wp2) 1002b, a trajectory plan point (Wp3) (not shown in figure), a trajectory plan point (Wp4) 1002d, a trajectory plan point (Wp5) (not shown in figure), and a trajectory plan point (Wp6) 1002f. It may be noted that an angle of deviation may be determined for each of the set of trajectory points in the performance 1000a. The set of angles of deviation may include an angle of deviation (α₁) (not shown in figure), an angle of deviation (α₂) 1003b, an angle of deviation (α₃) (not shown in figure), an angle of deviation (α₄) (not shown in figure), an angle of deviation (α₅) (not shown in figure), and an angle of deviation (α₆) (not shown in figure).

Further, the performance 1000a may include an end state 1004 of the AGV 105. It may be noted that the end state 1004 corresponds with the Wp6. A speed adjustment region 1005 corresponds to a region where the velocity range of the new TP may be generated in the current TP for the AGV 105. It may be noted that, in the performance 1000a, parking space in the parking lot 1001 is not wasted. Total alignment deviation (Tad) with respect to road or roadside parking may be determined as per equation (4) below:

Tad=α₁+(α₂−α₁)+(α₃−α₂)+(α₄−α₃)+(α₅−α₄)+(α₆−α₅) Equation (4)

In FIG. 10B, a simulated performance 1000b as per the current TP of the AGV 105 in a parking lot 1001 is illustrated. The simulated performance 1000b includes a set of trajectory points and a set of angles of deviation with respect to a roadside parking. The set of trajectory points may include a trajectory plan point (Wp′1) (not shown in figure), a trajectory plan point (Wp′2) 1006b, a trajectory plan point (Wp′3) (not shown in figure), and a trajectory plan point (Wp′4) 1006d. It may be noted that an angle of deviation may be determined for each of the set of trajectory points in the simulated performance 1000b. The set of angles of deviation may include an angle of deviation (α′₁) (not shown in figure), an angle of deviation (α′₂) 1007b, an angle of deviation (α′₃) (not shown in figure), and an angle of deviation (α′₄) 1007d.

Further, the simulated performance 1000b may include a projected end state 1004 of the AGV 105. It may be noted that the projected end state 1008 corresponds with the Wp′4. It may be noted that in the simulated performance 1000b, parking space in the parking lot 1001 is wasted. Total alignment deviation (Tad′) with respect to road or roadside parking may be determined as per equation (5) below:

Tad′=α′₁+(α′₂−α′₁)+(α′₃−α′₂)+(α′₄−α′₃) Equation (5)

It may be noted that Tad is more aligned with respect to the roadside than Tad′. In other words, Tad is less deviated with respect to the roadside than Tad′. As will be appreciated, a lower value of total alignment deviation is more desirable. It may be noted that in the simulated performance 1000b, parking space occupancy of the AGV 105 is less optimal as compared with the parking space occupancy of the AGV 105 in the performance 1000a. Therefore, the new TP may be more suitable to achieve the derived mission than the current TP.

Referring back to FIG. 4, the method 400 may further include trajectory planning and velocity generation, at step 404. A suitable waypoint follower algorithm may be used to move the AGV 105 towards a next waypoint. Further, a linear and an angular velocity may be generated for the AGV 105 based on the waypoint follower algorithm from the current location or a current waypoint to the next waypoint.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. The disclosed methods and systems may be implemented on a conventional or a general-purpose computer system, such as a personal computer (PC) or server computer.

Thus, the disclosed method and system succeed in overcoming the technical problem of dynamically determining TP for an AGV. The method and system determine a derived mission corresponding to a local objective along a global path based on static environment data from a navigation map and dynamic environment data acquired by the AGV. Further, the method and system identify one or more potential TPs from a plurality of TPs for achieving the derived mission. Further, the method and system calculate a weighted suitability score for each of the one or more potential TPs based on a set of TP evaluation parameters. Further, the method and system determine a new TP from the one or more potential TPs based on the weighted suitability score for each of the one or more potential TPs and a simulated evaluation of the new TP. The simulated evaluation includes determining a projected position of the AGV by simulating the new TP and evaluating the projected position with respect to the local objective. Therefore, the new TP may be dynamically determined based on the dynamic environment data. Further, the method and system succeed in overcoming the technical problem of seamlessly switching TP for the AGV. The method and system replace the current TP with the new TP by generating a velocity range corresponding to the new TP for at least one navigation cycle. Further, the method and system evaluate a performance of the new TP for at least one navigation cycle. Further, the method and system evaluate a simulated performance of the current TP. The performance and the simulated performance are compared with respect to the derived mission 903. Further, the method and system decide to switch back to the current TP or continue with the new TP based on the comparison.

As will be appreciated by those skilled in the art, the techniques described in the various embodiments discussed above are not routine, or conventional, or well understood in the art. The techniques discussed above provide for dynamically determining and seamlessly switching TP for an AGV 105. The techniques first determine a derived mission 903 at a current position of the AGV 105 along a global path based on static environment data from a navigation map and dynamic environment data acquired by the AGV 105. The derived mission 903 corresponds to a local objective (for example, finding parking space in a parking lot) of the AGV 105. The techniques may then identify one or more potential TPs 601 from a plurality of TPs based on the derived mission 903. The plurality of TPs includes a current TP of the AGV 105. The techniques may then calculate a weighted suitability score for each of the one or more potential TPs based on a set of TP evaluation parameters. The set of TP evaluation parameters includes at least one of an objective match score, a complexity score, and a data interpretation toughness score. The techniques may then determine a new TP from the one or more potential TPs 601 to achieve the derived mission 903 based on the weighted suitability score for each of the one or more potential TPs and a simulated evaluation of the new TP. The simulated evaluation for the new TP includes determining a projected position of the AGV 105 by simulating the new TP and evaluating the projected position with respect to the local objective.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for dynamically determining and seamlessly switching TP for an AGV 105. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of dynamically determining and seamlessly switching trajectory planner (TP) for an Autonomous Ground Vehicle (AGV), the method comprising:
determining, by a navigation device, a derived mission at a current position of the AGV along a global path based on static environment data from a navigation map and dynamic environment data acquired by the AGV, wherein the derived mission corresponds to a local objective of the AGV;
identifying, by the navigation device, one or more potential TPs from a plurality of TPs based on the derived mission, wherein the plurality of TPs comprises a current TP of the AGV;
calculating, by the navigation device, a weighted suitability score for each of the one or more potential TPs based on a set of TP evaluation parameters, wherein the set of TP evaluation parameters comprises at least one of an objective match score, a complexity score, and a data interpretation toughness score; and
determining, by the navigation device, a new TP from the one or more potential TPs to achieve the derived mission based on the weighted suitability score for each of the one or more potential TPs and a simulated evaluation of the new TP, wherein the simulated evaluation of the new TP comprises determining a projected pose of the AGV by simulating a new trajectory plan by the new TP and evaluating the projected pose with respect to the local objective.

2. The method of claim 1, wherein identifying the one or more potential TPs is further based on the dynamic environment data.

3. The method of claim 1, wherein determining the new TP comprises:
iteratively selecting a TP from the one or more potential TPs based on the weighted suitability score for each of the one or more potential TPs; and
performing the simulated evaluation of the selected TP, wherein the iteration is performed until the projected pose for the selected TP is within a predefined threshold of a desired pose of the AGV as per the local objective.

4. The method of claim 1, wherein the dynamic environment data acquired by the AGV comprises at least one of camera data, Light Detection and Ranging (LIDAR) data, or short-range Radio Detection and Ranging (RADAR) data.

5. The method of claim 1, wherein the weighted suitability score is directly proportional to the objective match score and is inversely proportional to at least one of the complexity score and the data interpretation toughness score.

6. The method of claim 1, further comprising:
replacing, by the navigation device, the current TP with the new TP for at least one navigation cycle; and
evaluating, by the navigation device, an impact of the replacement by:
evaluating a performance of the AGV with respect to the derived mission based on navigation performed as per the new TP;
evaluating a simulated performance of the AGV with respect to the derived mission based on simulated navigation as per the current TP; and
comparing the performance of the AGV with the simulated performance of the AGV to decide between continuing with the new TP or switching back to the current TP.

7. The method of claim 6, further comprising switching, by the navigation device, back to the current TP based on the evaluation of the impact.

8. A system for dynamically determining and seamlessly switching trajectory planner (TP) for an Autonomous Ground Vehicle (AGV), the system comprising:
a processor; and
a computer-readable medium communicatively coupled to the processor, wherein the computer-readable medium stores processor-executable instructions, which when executed by the processor, cause the processor to:
determine a derived mission at a current position of the AGV along a global path based on static environment data from a navigation map and dynamic environment data acquired by the AGV, wherein the derived mission corresponds to a local objective of the AGV;
identify one or more potential TPs from a plurality of TPs based on the derived mission, wherein the plurality of TPs comprises a current TP of the AGV;
calculate a weighted suitability score for each of the one or more potential TPs based on a set of TP evaluation parameters, wherein the set of TP evaluation parameters comprises at least one of an objective match score, a complexity score, and a data interpretation toughness score; and
determine a new TP from the one or more potential TPs to achieve the derived mission based on the weighted suitability score for each of the one or more potential TPs and a simulated evaluation of the new TP, wherein the simulated evaluation of the new TP comprises determining a projected pose of the AGV by simulating a new trajectory plan by the new TP and evaluating the projected pose with respect to the local objective.

9. The system of claim 8, wherein identifying the one or more potential TPs is further based on the dynamic environment data.

10. The system of claim 8, wherein to determine the new TP, the processor-executable instructions, on execution, cause the processor to:
iteratively select a TP from the one or more potential TPs based on the weighted suitability score for each of the one or more potential TPs; and
perform the simulated evaluation of the selected TP, wherein the iteration is performed until the projected pose for the selected TP is within a predefined threshold of a desired pose of the AGV as per the local objective.

11. The system of claim 8, wherein the dynamic environment data acquired by the AGV comprises at least one of camera data, Light Detection and Ranging (LIDAR) data, or short-range Radio Detection and Ranging (RADAR) data.

12. The system of claim 8, wherein the weighted suitability score is directly proportional to the objective match score and is inversely proportional to at least one of the complexity score and the data interpretation toughness score.

13. The system of claim 8, wherein the processor-executable instructions, on execution, further cause the processor to:
replace the current TP with the new TP for at least one navigation cycle; and
evaluate an impact of the replacement by:
evaluating a performance of the AGV with respect to the derived mission based on navigation performed as per the new TP;
evaluating a simulated performance of the AGV with respect to the derived mission based on simulated navigation as per the current TP; and
comparing the performance of the AGV with the simulated performance of the AGV to decide between continuing with the new TP or switching back to the current TP.

14. The system of claim 13, wherein the processor-executable instructions, on execution, further cause the processor to switch back to the current TP based on the evaluation of the impact.

15. A non-transitory computer-readable medium storing computer-executable instructions for dynamically determining and seamlessly switching trajectory planner (TP) for an Autonomous Ground Vehicle (AGV), the computer-executable instructions are executed for:
determining a derived mission at a current position of the AGV along a global path based on static environment data from a navigation map and dynamic environment data acquired by the AGV, wherein the derived mission corresponds to a local objective of the AGV;
identifying one or more potential TPs from a plurality of TPs based on the derived mission, wherein the plurality of TPs comprises a current TP of the AGV;
calculating a weighted suitability score for each of the one or more potential TPs based on a set of TP evaluation parameters, wherein the set of TP evaluation parameters comprises at least one of an objective match score, a complexity score, and a data interpretation toughness score; and
determining a new TP from the one or more potential TPs to achieve the derived mission based on the weighted suitability score for each of the one or more potential TPs and a simulated evaluation of the new TP, wherein the simulated evaluation of the new TP comprises determining a projected pose of the AGV by simulating a new trajectory plan by the new TP and evaluating the projected pose with respect to the local objective.

16. The non-transitory computer-readable medium of claim 15, wherein identifying the one or more potential TPs is further based on the dynamic environment data.

17. The non-transitory computer-readable medium of claim 15, wherein for determining the new TP, the computer-executable instructions are further executed for:
iteratively selecting a TP from the one or more potential TPs based on the weighted suitability score for each of the one or more potential TPs; and
performing the simulated evaluation of the selected TP, wherein the iteration is performed until the projected pose for the selected TP is within a predefined threshold of a desired pose of the AGV as per the local objective.

18. The non-transitory computer-readable medium of claim 15, wherein the weighted suitability score is directly proportional to the objective match score and is inversely proportional to at least one of the complexity score and the data interpretation toughness score.

19. The non-transitory computer-readable medium of claim 15, wherein the computer-executable instructions are further executed for:
replacing the current TP with the new TP for at least one navigation cycle; and
evaluating an impact of the replacement by:
evaluating a performance of the AGV with respect to the derived mission based on navigation performed as per the new TP;
evaluating a simulated performance of the AGV with respect to the derived mission based on simulated navigation as per the current TP; and
comparing the performance of the AGV with the simulated performance of the AGV to decide between continuing with the new TP or switching back to the current TP.

20. The non-transitory computer-readable medium of claim 19, wherein the computer-executable instructions are further executed for:
switching back to the current TP based on the evaluation of the impact.
